(19) United States
(12) Patent Application Publication
(10) Pub. No.: US 2010/0013217 A1
(43) Pub. Date: Jan. 21, 2010

(54) Tube joint and method of joining tubes in an engine exhaust system

(75) Inventors: Robert Raymond Petkovsek, Neillsville, WI (US); Walter J. Ormond, Neillsville, WI (US)

Correspondence Address: KRIEG DEVAULT LLP, ONE INDIANA SQUARE, SUITE 2800, INDIANAPOLIS, IN, 46204-2079, US

(73) Assignee: Cummins Filtration IP, Inc.

(21) Appl. No.: 12/218,573

(22) Filed: Jul. 16, 2008

(51) Int. Cl. F16L 25/00

(52) U.S. Cl. 285/328; 285/420

(57) ABSTRACT

A substantially leak free joint connecting conduits in an exhaust system of an engine. The joint connects a first exhaust conduit extending between a first distal end and a first join end, and a second exhaust conduit extending between a second distal end and a second join end. The joint comprises a substantially circular bead formed by a tip of the first join end curled radially outward and around until it contacts an outer surface of the first exhaust conduit. A mating surface formed in the second join end that defines an at least partially axially open seat flared radially outward from the second exhaust conduit. At least a portion of the seat shaped to substantially conform to at least ninety degrees of a circumference of an external surface of the substantially circular bead. The external surface of the bead directly contacts the seat of the mating surface such that the portion of the seat curves around a portion of the circumference of the bead.

### BACKGROUND OF THE INVENTION

The present invention relates to a method for connecting tubes in an exhaust system in a substantially leak free or leak free joint. Typical exhaust components and pipes which comprise exhaust systems are usually exposed to corrosive environments (internally, from the hot and acidic exhaust gases; and externally, from weather and road debris) and are operated in harsh conditions. In many piping systems, particularly exhaust purifying systems which utilize an additional reagent or fluid for NOₓ reduction or filter heating, the connections must be substantially leak-proof.

### SUMMARY OF THE INVENTION

In one embodiment of the present invention a tubing joint in an exhaust system of an engine comprises a first tube having a distal end and a curling end. A tip of the curling end is curled radially outward and contacts an outer surface of the first tube to form a substantially circular bead at the curling end of the first tube. A second tube having a far end and a mating end, the mating end being flared radially outward to define a seat that is shaped to conform with at least a portion of an external surface of the bead. The first tube is joined to the second tube by positioning the bead of the curling end within the seat of the mating end.

In one refinement of the embodiment an inner surface of the mating end of the second tube circumferentially overlaps at least ninety degrees of the external surface of the bead of the first tube.

In another refinement of the embodiment at least one of the first tube and the second tube has a bend therein.

In another refinement of the embodiment the first tube and the second tube are stainless steel, and the joint does not include a gasket.

In another refinement of the embodiment the tube also comprises a V-band clamp that extends around a circumference of the joint, and wherein the V-band clamp axially and radially overlaps the seat of the mating end and the bead of the curling end.

In another refinement of the embodiment, substantially adjacent to a tip of the mating end, there is a radially inward dimple that contacts the external surface of the bead.

In another refinement of the embodiment an inner surface of the mating end of the second tube circumferentially overlaps over one hundred eighty degrees of the external surface of the bead of the first tube, and substantially the entire seat contacts the external surface of the bead.

In another refinement of the embodiment the first tube and the second tube are stainless steel, and wherein the joint does not include a gasket.

Another embodiment of the present invention is a method of connecting a first tube to a second tube in an engine exhaust system with a substantially leak free joint, comprises creating a substantially circular radially outward bead at a join end of the first tube by moving a curling die relative to the first tube along an axis. The curling die containing a groove having a radius such that a tip of the join end bends radially outward and around to contact an outer surface of the first tube to form the bead. Forming a seat in a mating end of the second tube using a second die to flare the mating end radially outward, and a third die to shape the seat so that a least a portion of the seat substantially conforms to at least ninety degrees of a circumference of an external surface of the substantially circular bead. Positioning the substantially circular bead of the first tube within the seat of the mating end of the second tube such that the portion of the seat is in contact with the external surface of the bead.

One refinement of the embodiment comprises first clamping the first tube into a fixed position, and the curling die is moved relative to the first tube by forcing the first die toward the join end of the first tube.

In another refinement of the embodiment the first tube is a bent tube.

In another refinement of the embodiment the first tube and the second tube are stainless steel, and the joint is created without a gasket.

Another refinement of the embodiment comprises adding a radially inward dimple to a tip of the mating end of the second tube, the dimple contacting the external surface of the bead.

In another refinement of the embodiment the seat substantially conforms to at least one hundred eighty degrees of the circumference of the external surface of the substantially circular bead.

Another refinement of the embodiment comprises positioning a V-band clamp around a circumference of the joint such that the clamp radially and axially overlaps the seat and the bead.

In another refinement of the embodiment the seat does not extend around the entire circumference of the bead.

Another embodiment of the present invention is a substantially leak free joint connecting conduits in an exhaust system of an engine. The joint comprises a first exhaust conduit extending between a first distal end and a first join end. It also comprises a second exhaust conduit extending between a second distal end and a second join end; and a joint connecting the first join end to the second join end. The joint comprises a substantially circular bead formed by a tip of the first join end curled radially outward and around until it contacts an outer surface of the first exhaust conduit. The joint also comprises a mating surface formed in the second join end that defines an at least partially axially open seat flared radially outward from the second exhaust conduit, at least a portion of the seat shaped to substantially conform to at least ninety degrees of a circumference of an external surface of the substantially circular bead. The external surface of the substantially circular bead directly contacts the seat of the mating surface such that the portion of the seat curves around a portion of the circumference of the bead.

In another refinement of the embodiment the joint does not include a gasket.

In another refinement of the embodiment the first conduit and the second conduit are stainless steel.

In another refinement of the embodiment at least one of the first tube and the second tube has a bend therein.

Another refinement of the embodiment comprises a V-band clamp that extends around a circumference of the joint and axially and radially overlaps the seat and the bead.

In another refinement of the embodiment an inner surface of the seat circumferentially overlaps at least one hundred eighty degrees of the external surface of the bead, and substantially the entire seat contacts the external surface of the bead.

In another refinement of the embodiment the seat does not overlap the entire circumference of the bead.

Related objects and advantages of the present invention will be apparent from the following description.

### BRIEF DESCRIPTION OF THE FIGURES

FIG. 1 is a cross-sectional view of an end of a tube adjacent to a curling die.

FIG. 2 is the view of FIG. 1 after the die and tube have been moved relative to one another to curl the end of the tube.

FIG. 3 is a cross-sectional view of another tube being flared outward by a die.

FIG. 4 is a cross-sectional of the tube of FIG. 3 during processing in an additional die.

FIG. 5 is a side view of the shape of a mating tube.

FIG. 6 is a perspective end view of a first embodiment of a tube joint before assembly of the tubes.

FIG. 7 is a cross-sectional view of FIG. 6 after assembly of the two tubes.

FIG. 8 is a cross-sectional view of a long lip no lock embodiment of a tube joint.

FIG. 9 is a cross-sectional view of a dimple lock embodiment of a tube joint.

FIG. 10 is a cross-sectional view of a full lock embodiment of a tube joint.

FIG. 11 is a cross-sectional view of a V-band lock embodiment of a tube joint.

FIG. 12 is an end view of one style of clamp.

FIG. 13 is a section view of the clamp of FIG. 12 along the lines 13-13.

FIG. 14 is an end view of another style of clamp.

FIG. 15 is an end view of another style of clamp.

### DETAILED DESCRIPTION OF THE PREFERRED EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The present invention relates generally to a method for joining tubes that can be used, for example, with internal combustion engines, such as diesel or gasoline powered engines. Such joined tubes are important since various portions of the exhaust system used in vehicle engines are susceptible to corrosion by water, sand, dirt and other particulate materials. Impurities such as products of combustion, soot, moisture, dust, abrasion powder, etc. mix and pass out the exhaust system every moment during the operation of an automobile's engine. Thus, there are many applications for tube joints according to the present invention. For example, the tube joints can be used in exhaust systems for farm equipment, construction equipment, skidders, loaders, other off-road vehicles, heavy-duty highway trucks, automobiles, and other vehicles. In one embodiment, the invention relates to curling a first tube to form a bead. A mating part is then formed on a second tube in two operations, first flaring the second tube out to get enough metal in position and then forming the join end of the second tube to mate with the beaded tube.

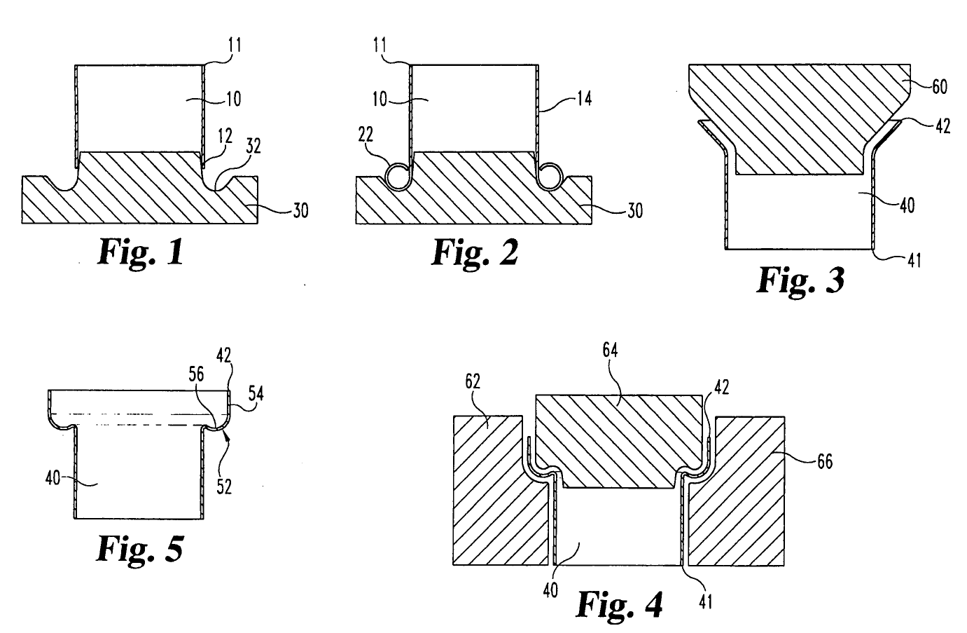

With reference to FIGS. 1 and 2, there are illustrated aspects of forming a bead having a substantially circular cross-section at the end of a tube. The process of forming a bead illustrated therein is similar to the process of forming a multi-walled tube as disclosed in U.S. Ser. No. 11/588,803 filed 27 Oct. 2006 and entitled “Multi-Walled Tube And Method Of Manufacture”, assigned to the assignee of the present application, and incorporated herein by reference. However, the curling die used is preferably different so that the bead forms all the way back to the outer diameter of the tube (in contrast, in the double wall tube the curling die is made so the metal does not quite roll tight to the tube, and thus can continue to be pushed to create the double wall). Additionally, the tooling is slightly different in that the curl diameter is preferably larger in the multi-wall tube application. In the present application, formation of the bead is such that the tip of the tube curls around and contacts the tube and stops. As an example, the multi-wall tube preferably, but not necessarily, has a larger radius. In one application of the present invention the radius of the bead is about 0.187 inches.

With further reference to FIGS. 1 and 2, the tube 10 has a wall 14 that extends between a far end 11 and a curling or join end 12. The tube 10 extends axially between the two ends and the curling end 12 is positioned adjacent to a curling die 30. As illustrated in FIG. 1, the curling end 12 is aligned with the annular groove 32 of curling die 32. With reference to FIG. 2, the curling die 30 has been moved relative to the tube 10. The tip of the curling end 12 has been forced through the annular groove 32 and has curled radially outward and around until it contacts the radially outer surface of wall 14 to form a substantially circular bead 22.

It should be understood that it is contemplated as within the scope of the invention that the axial movement of the tube 10 relative to curling die 30 may occur in a variety of ways. In one method, the tube 10 is translated axially while the curling die 30 is held fixed in position. In another method, both the tube 10 and the curling die 30 are translated toward one another. However, in the more preferred method, the tube 10 is fixed into position by a clamp (not illustrated) and the die 30 is forced onto the end 12 of tube 10 to form the bead 22. Fixing the tube 10 into position and translating the curling die 30 permits the apparatus and method of the present invention to be more readily used, for example, with bent tubes. Movement of tube 10 relative to curl die 30 flows the tube 10 into a round and strong bead 22. Many commercial applications contemplated as within the scope of the invention will entail forcing the die 30 onto the tube 10 since the bead will be formed on bent tubes, and the bent tube 10 will be clamped in a fixed position to allow the die 30 to do its work.

With reference to FIGS. 3-5, there are illustrated aspects of forming a second tube 40 having a mating end to match and be joined to beaded end of tube 10. More particularly, formation of a mating part to be joined to the substantially circular bead 22 at the curling end 12 of tube 10. Second tube 40 extends between distal end 41 and join or mating end 42.

With reference to FIG. 3, in a first step the mating or join end 42 of tube 40 is forced against a first die 60. Again, the relative movement of tube 40 to die 60 might occur in a variety of ways. Such relative movement, however, flares a length of tube 40 at end 42 radially outward. Such length of tube 40 preferably corresponds to that necessary to form a seat for the bead 22 of tube 10.

With reference to FIG. 4, in a second step the mating or join end 42 of tube 40 is forced through a plurality of dies 62, 64, and 66. The dies 62, 64 and 66 induce the mating or join end 42 of tube 40 to flow into the shape of a seat 52 as illustrated in FIG. 5. Seat 52 includes a substantially axially facing portion 56 and a substantially radially facing lip portion 54.

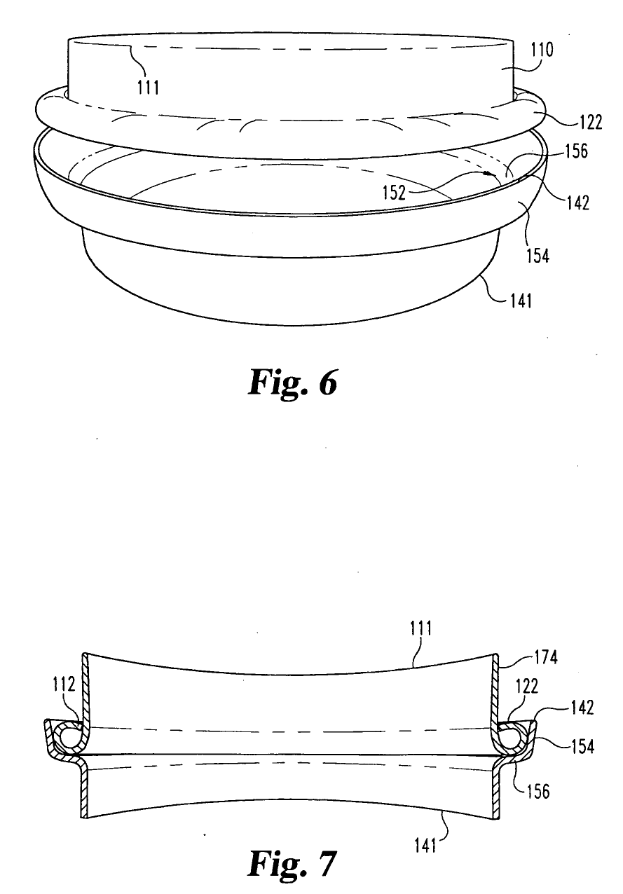

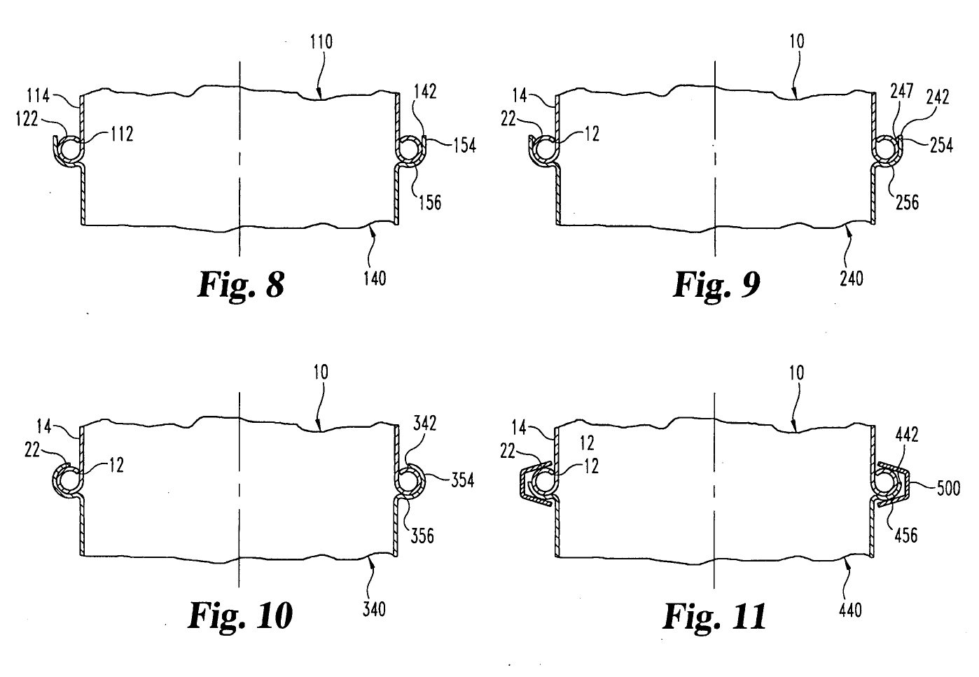

With reference to FIGS. 6-8, there is illustrated one embodiment of a joint of the present invention having a long lip portion with no lock. A first tube 110 has a distal end 111 and a join end 112. The tip of join end 112 curls radially outward and around to contact the outer surface of the wall 114 to form a substantially circular bead 122. The second tube 140 extends between a distal end 141 and a join end 142. Join end 142 includes a lip portion 154 and a seat portion 156. The seat portion 156 preferably substantially conforms to the external surface of the circular bead 122. The two tubes are positioned so that the bead 122 of the first tube 110 preferably directly contacts the seat portion 156 of join end 142 of second tube 140.

With reference to FIGS. 9-11 there are illustrated three additional embodiments of a joint having a dimple lock, full lock, and V-band lock, respectively. In each of FIGS. 9-11 like reference numerals are the same as those used previously. That is to say, as in FIGS. 1-2, the first tube 10 has a tip at join end 12 that curls radially outward and around to contact the outer surface of the wall 14 to form a substantially circular bead 22.

With reference to FIG. 9 there is illustrated a dimple lock joint between a first tube 10 and a second tube 240. The second tube 240 extends between a distal end and a join end 242. Join end 242 includes a lip portion 254 and a seat portion 256. The seat portion 256 substantially conforms to the external surface of the circular bead 22. The two tubes are positioned so that the bead 22 of the first tube 10 directly contacts the seat portion 256 of join end 242 of second tube 240. At or substantially adjacent to the tip of join end 242 of tube 240 is a radially inwardly protruding dimple 247 formed after the two tubes are positioned together. The dimple 247 acts as a lock to prevent separation of the joined tubes.

With reference to FIG. 10 there is illustrated a full lock joint between a first tube 10 and a second tube 340. The second tube 340 extends between a distal end and a join end 342. Join end 342 includes a lip portion 354 and a seat portion 356. The seat portion 356 substantially conforms to the external surface of the circular bead 22. The two tubes are positioned so that the bead 22 of the first tube 10 directly contacts the seat portion 356 of join end 342 of second tube 340. Additionally, the lip portion 354 curves radially inward and preferably also substantially conforms to the external surface of the circular bead. The combination of the seat portion 356 and the lip portion 354 of join end 342 of the second tube overlap one hundred eighty degrees or more of the circumference of the external surface of the bead 22, acting as a lock to prevent separation of the joined tubes.

With reference to FIG. 11 there is illustrated a V-band lock joint between a first tube 10 and a second tube 440. The second tube 440 extends between a distal end and a join end 442. Join end 442 includes a seat portion 456 and might also include a short lip portion. The seat portion 456 substantially conforms to the external surface of the circular bead 22. The two tubes are positioned so that the bead 22 of the first tube 10 directly contacts the seat portion 456 of join end 442 of second tube 440. Additionally, a V-band clamp 500 axially and radially overlaps the join end 442 and bead 22 of join end 12. The combination of the seat 456 directly contacting the bead 22 and the V-band clamp that encompasses substantially all of the join ends 12 and 442 acts as a lock to prevent separation of the joined tubes.

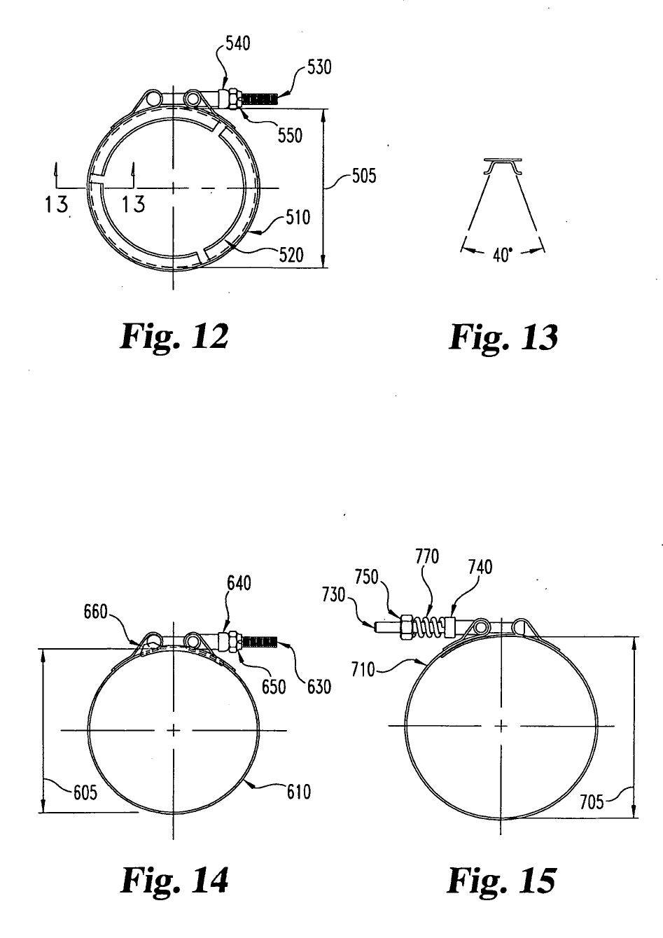

With reference to FIGS. 12-13, there are illustrated aspects of one style of a V-band clamp 500. Clamp 500 includes a band 510 having a nominal diameter 505. Band 510 further encloses retainer 520 that is in three pieces. The clamp 500 further includes a T-bolt 530, trunnion 540 and nut 550.

With reference to FIG. 14, there are illustrated aspects of another style of a V-band clamp 600. Clamp 600 includes a band 610 having a nominal diameter 605. The clamp 600 further includes a T-bolt 630, trunnion 640 and nut 650. Clamp 600 further includes a self-centering flanged floating bridge 660.

With reference to FIG. 15, there are illustrated aspects of another style of a V-band clamp 700. Clamp 700 includes a band 710 having a nominal diameter 705. The clamp 700 further includes a T-bolt 730, trunnion 740, nut 750, and spring 770. The nut 750 is illustrated in the torqued state.

The above described bands are preferably stainless steel bands and have full rounded edges. The fasteners are preferably stainless steel and rated for 800° F. The nuts should not loosen when the clamp is subjected to vibration. The trunnion of the clamp preferably does not contact the clamp band or loop in the assembled and torqued condition.

The above described full lock and V-band lock embodiments have been reduced to practice and found to provide substantially leak free joints. The V-band connection might be preferred in some commercial applications because it is removable. However, a permanent joint might be preferred in other commercial applications in which it is considered more important to eliminate the clamp cost. Tubes and accompanying joints of the present invention in engine exhaust systems are preferably made of stainless steel which makes for a very difficult part to form.

“Tube” has the common dictionary meaning of a hollow cylinder, and includes “pipe”, “duct” and similar terms. No particular cross-section is implied by the term, but commonly a tube is of circular cross-section, and the discussion above will refer to such tubes. It will be evident from the discussion that tubes of non-circular cross-section, for example oval cross-section, can also be releasably connected with the clamped tube joint and method of this invention. The clamped tube joint of this invention is particularly adaptable to joining exhaust system components. Further, while tubes are generally of constant or relatively constant diameter, the word “tube” as used in this application also includes tubes having diameters varying along their length.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A tubing joint in an exhaust system of an engine comprising:
a first tube having a distal end and a curling end, wherein a tip of the curling end is curled radially outward and contacts an outer surface of the first tube to form a substantially circular bead at the curling end of the first tube;
a second tube having a far end and a mating end, the mating end being flared radially outward to define a seat that is shaped to conform with at least a portion of an external surface of the bead; and
wherein the first tube is joined to the second tube by positioning the bead of the curling end within the seat of the mating end.

2. The tubing joint of claim 1, and wherein an inner surface of the mating end of the second tube circumferentially overlaps at least ninety degrees of the external surface of the bead of the first tube.

3. The tubing joint of claim 2, wherein at least one of the first tube and the second tube has a bend therein.

4. The tubing joint of claim 3, wherein the first tube and the second tube are stainless steel, and wherein the joint does not include a gasket.

5. The tubing joint of claim 2, further comprising a V-band clamp that extends around a circumference of the joint, and wherein the V-band clamp axially and radially overlaps the seat of the mating end and the bead of the curling end.

6. The tubing joint of claim 1, wherein substantially adjacent to a tip of the mating end there is a radially inward dimple that contacts the external surface of the bead.

7. The tubing joint of claim 1, wherein an inner surface of the mating end of the second tube circumferentially overlaps over one hundred eighty degrees of the external surface of the bead of the first tube, and wherein substantially the entire seat contacts the external surface of the bead.

8. The tubing joint of claim 7, wherein the first tube and the second tube are stainless steel, and wherein the joint does not include a gasket.

9. A method of connecting a first tube to a second tube in an engine exhaust system with a substantially leak free joint, comprising:
creating a substantially circular radially outward bead at a join end of the first tube by moving a curling die relative to the first tube along an axis, the curling die containing a groove having a radius such that a tip of the join end bends radially outward and around to contact an outer surface of the first tube to form the bead;
forming a seat in a mating end of the second tube using a second die to flare the mating end radially outward and a third die to shape the seat so that a least a portion of the seat substantially conforms to at least ninety degrees of a circumference of an external surface of the substantially circular bead;
positioning the substantially circular bead of the first tube within the seat of the mating end of the second tube such that the portion of the seat is in contact with the external surface of the bead.

10. The method of claim 9, further comprising first clamping the first tube into a fixed position, and wherein the curling die is moved relative to the first tube by forcing the first die toward the join end of the first tube.

11. The method of claim 10, wherein the first tube is a bent tube.

12. The method of claim 11, wherein the first tube and the second tube are stainless steel, and the joint is created without a gasket.

13. The method of claim 12, further comprising adding a radially inward dimple to a tip of the mating end of the second tube, the dimple contacting the external surface of the bead.

14. The method of claim 9, wherein the seat substantially conforms to at least one hundred eighty degrees of the circumference of the external surface of the substantially circular bead.

15. The method of claim 9, further comprising positioning a V-band clamp around a circumference of the joint such that the clamp radially and axially overlaps the seat and the bead.

16. The method of claim 9, wherein the seat does not extend around the entire circumference of the bead.

17. A substantially leak free joint connecting conduits in an exhaust system of an engine, comprising:
a first exhaust conduit extending between a first distal end and a first join end;
a second exhaust conduit extending between a second distal end and a second join end;
a joint connecting the first join end to the second join end, the joint comprising:
a substantially circular bead formed by a tip of the first join end curled radially outward and around until it contacts an outer surface of the first exhaust conduit;
a mating surface formed in the second join end that defines an at least partially axially open seat flared radially outward from the second exhaust conduit, at least a portion of the seat shaped to substantially conform to at least ninety degrees of a circumference of an external surface of the substantially circular bead; and
wherein the external surface of the substantially circular bead directly contacts the seat of the mating surface such that the portion of the seat curves around a portion of the circumference of the bead.

18. The apparatus of claim 17, wherein the joint does not include a gasket.

19. The apparatus of claim 18, wherein the first conduit and the second conduit are stainless steel.

20. The apparatus of claim 19, wherein at least one of the first tube and the second tube has a bend therein.

21. The apparatus of claim 20, further comprising a V-band clamp that extends around a circumference of the joint and axially and radially overlaps the seat and the bead.

22. The apparatus of claim 19, wherein an inner surface of the seat circumferentially overlaps at least one hundred eighty degrees of the external surface of the bead, and wherein substantially the entire seat contacts the external surface of the bead.

23. The apparatus of claim 22, wherein the seat does not overlap the entire circumference of the bead.
